(19) United States
(12) Patent Application Publication
(10) Pub. No.: US 2011/0008628 A1
(43) Pub. Date: Jan. 13, 2011

(54) AQUEOUS POLYURETHANE RESIN COMPOSITION AND COATED ARTICLES COMPOSED OF BEING COATED WITH THE SAME

(75) Inventors: Naohiro Fujita, Saitama (JP); Akira Nakatsuji, Saitama (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: ADEKA CORPORATION, Tokyo (JP)

(21) Appl. No.: 12/919,873

(22) PCT Filed: Feb. 2, 2009
(86) PCT No.: PCT/JP2009/000380

§ 371 Date: Aug. 27, 2010

(30) Foreign Application Priority Data
Feb. 27, 2008 (JP) 2008-045921

(51) Int. Cl. B32B 15/095; C08L 75/04; B32B 27/40

(52) U.S. Cl. 428/425.8; 524/591; 428/423.1

(57) ABSTRACT

The present invention is an aqueous polyurethane resin composition, which has excellent water resistance properties and chemical resistance properties etc. and is suitably available for a coating composition for surface-treated steels, characterized in that an isocyanurate compound (a) represented by the following general formula (1), a long-chain alkylenediol compound (b) having 10-32 carbon atoms, a polyisocyanate compound (c), a polyol compound (d), an anionic group-introducing compound (e), an anionic group neutralizing agent (f) and water are essential components.

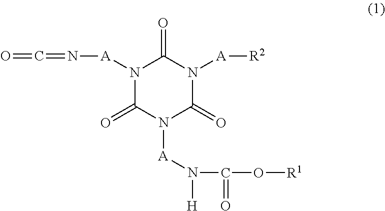

A, R¹ and R² in the general formula (1) are described in Claim 1.

### FIELD OF THE INVENTION

The present invention relates to an aqueous polyurethane resin composition, and in particular to an aqueous polyurethane resin composition that can realize water resistance and chemical resistance (acid resistance, alkali resistance) (hereafter these are generally called barrier properties in some cases), and to the coated articles wherein surfaces of their plate materials are coated with said aqueous polyurethane resin composition.

### BACKGROUND OF THE INVENTION

Polyurethane resin is widely used as coating compositions, adhesive agents, binders and coating agents etc. since it is suitable for coating film and molded articles which have abrasion resistance, adhesive properties, non-tacky properties and rubber elasticity.

Recently, there are lots of reports of aqueous polyurethane resin composition studied from safety standpoints such as anti-environmental pollution and labor hygiene. And it has been pointed out that aqueous polyurethane resin composition has a problem where it is inferior to solvent type or solventless type polyurethane resin composition in physical properties such as water resistance, chemical resistance (acid resistance, alkali, resistance), heat resistance and tensile properties.

In fact, even now aqueous polyurethane resin composition does still not have satisfactory water resistance and chemical resistance (acid resistance, alkali resistance), which are essential conditions particularly when used as, for example, a coating composition for surface-treated steels.

A smoothly-detachable hard adhesive material was proposed wherein a polyisocyanate obtained by reacting polyisocyanate with monofunctional aliphatic derivative is used as a base (Patent Document 1). However, it is not suggested at all to use an aqueous polyurethane resin obtained by combining a polyol component with an anionic group-introduced compound.

### [Patent Document 1] Japanese Unexamined Patent Publication Tokuhyo 2000-506187

On the other hand, in order to improve water-repellent properties and oil-repellant properties, a fluorinated polymer, which is obtained by reacting a polyoxyalkylene-containing substance with a reaction product of polyfunctional isocyanate and fluorinated alcohol, was proposed (Patent Document 2). However, this fluorinated polymer does not have good adhesive properties with steel plates. Therefore, it is not suitable for the fluorinated polymer to be used as a coating composition for steel plates.

### [Patent Document 2] Japanese Unexamined Patent Publication Tokuhyohei 11-511814

In addition, an aqueous polyurethane resin containing a long-chain alkyl group as a side chain, which is an aqueous polyurethane resin having improved water resistance, chemical resistance (acid resistance, alkali resistance), heat resistance etc. was disclosed. However, when this aqueous polyurethane resin is made by using a branched diol having a short main chain and a side chain of long-chain alkyl group, produced urethane prepolymer aggregates since urethane bonds having high cohesive energy are close to each other (Patent Documents 3˜5). Hereby, viscosity rises and it makes water dispersion difficult.

### [Patent Document 3] Japanese Unexamined Patent Publication Tokkai 2000-007909

### [Patent Document 4] Japanese Unexamined Patent Publication Tokuhyo 2005-510600

### [Patent Document 5] Japanese Unexamined Patent Publication Tokkai 2005-068228

When a branched diol having a long main chain is used (Patent Document 6), hydrophobicity rises by a long-chain alkylene group incorporated into the urethane main chain and water dispersibility declines. A water dispersion type polyurethane composition composed of an isocyanurate compound having a long-chain alkyl group, polyol and water is disclosed (Patent Document 7). However, neither satisfactory water resistance nor chemical resistance is obtained.

Thus, there is a limitation to improve barrier properties of an aqueous polyurethane resin by introducing a long-chain alkyl group as a side chain into the aqueous polyurethane resin, or introducing a long-chain alkylene group into a main chain. Therefore, an aqueous polyurethane resin having satisfactory barrier properties is not obtained yet.

### [Patent Document 6] Japanese Unexamined Patent Publication Tokuhyo 2004-502000

[Patent Document 7] WO06/038466 Official gazette (See. “Problems to be solved by the invention”)

### DISCLOSURE OF THE INVENTION

### Problems to be Solved by the Invention

It is therefore the first object of the present invention to provide an aqueous urethane resin composition excellent in water resistance and chemical resistance (acid resistance, alkali resistance) etc., and suitably available for a coating composition for surface-treated steels.

It is the second object of the present invention to provide plate-like coated articles excellent in water resistance and chemical resistance as well as excellent in safety such as anti-environmental pollution and labor hygiene.

### Means to Solve the Problems

The present inventors found, as a result of studies to achieve the above objects, that an aqueous urethane resin composition excellent in water resistance and chemical resistance (acid resistance, alkali resistance) etc. can be obtained by using an isocyanurate compound having a long-chain alkyl group and a long-chain alkylenediol compound.

Namely, the present invention is an aqueous polyurethane resin composition characterized in that (a) an isocyanurate compound represented by the following general formula (1), (b) a long-chain alkylenediol compound having 10-32 carbon atoms, (c) a polyisocyanate compound, (d) a polyol compound, (e) an anionic group-introducing compound, (f) an anionic group neutralizing agent and water are essential components;

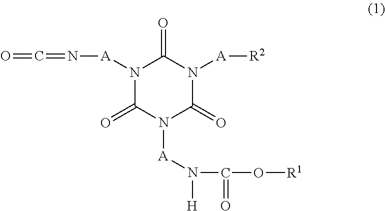

wherein R¹ represents an alkyl group having 10-32 carbon atoms, R² is —N═C═O (isocyanate group), or

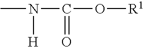

and A represents a residue produced by removing two —N═C═O groups from a diisocyanate compound.

It is preferable that A in the above general formula (1) is a hexamethylene group produced by removing two —N═C═O groups from 1,6-hexamethylenediisocyanate. It is preferable that R¹ is an alkyl group having 12-18 carbon atoms and R² is —N═C═O.

It is preferable that a long-chain alkylenediol compound used in the present invention is a diol having 12-18 carbon atoms.

### EFFECT OF THE INVENTION

An aqueous polyurethane resin composition, which is excellent in water resistance and chemical resistance (acid resistance, alkali resistance) etc., and, in particular, suitably available for surface-treated steels can be obtained by the present invention.

### DESCRIPTION OF THE PREFERRED EMBODIMENTS

In the present invention, an isocyanurate compound represented by the above general formula (1) used as a component (a) is obtained by adding long-chain alkyl alcohols to isocyanurate (trimer) of the diisocyanate compound.

Herein, examples of the diisocyanate compound which can form the isocyanurate are aromatic diisocyanates such as tolylene diisocyanate, diphenylmethane-4,4′-diisocyanate, p-phenylene diisocyanate, xylylene diisocyanate, 1,5-naphthylene diisocyanate, 3,3′-dimethyldiphenyl-4,4′-diisocyanate, dianisidine diisocyanate and tetramethylxylylene diisocyanate; alicyclic diisocyanates such as isophorone diisocyanate, dicyclohexylmethane-4,4′-diisocyanate, trans and/or cis-1,4-cyclohexane diisocyanate and norbornene diisocyanate; aliphatic diisocyanates such as 1,6-hexamethylene diisocyanate, 2,2,4 and/or (2,4,4)-trimethylhexamethylene diisocyanate and lysine diisocyanate; and mixtures thereof. When 1,6-hexamethylene diisocyanate, dicyclohexylmethane-4,4′-diisocyanate and isophorone diisocyanate are used among them, an aqueous polyurethane resin composition excellent in adhesive properties, corrosive resistance and strength etc. is obtained, which is preferable.

Herein, the isocyanurate is obtained by a known polymerization in an inactive solvent such as methyl acetate, ethyl acetate, butyl acetate, methylethyl ketone and dioxane; or in the elasticizers such as phthalate esters, for example, diethyl phthalate, dibutyl phthalate, di-2-ethylhexyl phthalate, mixed alkyl phthalate having alkyl group of 7-11 carbon atoms (hereafter described as C₇˜C₁₁), butyl benzyl phthalate and hexanol benzyl phthalate; phosphate esters, for example, tris cresyl phosphate, tris phenylphosphate; adipate esters, for example, di-2-ethylhexyl adipate; or trimellitic acid esters such as mixed trimellitate having C₇˜C₁₁ alkyl group, with known catalysts such as tertiary amine, quaternary ammonium compound, Mannich base, fatty acid alkali metal and alcoholate. When polymerization reaction is carried out in a highly volatile solvent, it is preferable to perform finally a solvent substitute treatment by a suitable solvent having a high boiling point such as an elasticizer.

The above-mentioned long-chain alkyl alcohols which is added to the isocyanurate of diisocyanate compound are monoalcohol compounds having 10-32 carbon atoms. Examples of them are straight chain or branched alcohols such as decanol, undecanol, dodecanol, tridecanol, tetradecanol, pentadecanol, hexadecanol, heptadecanol, octadecanol, nonadecanol, icosanol, henicosanol, docosanol, tricosanol, tetracosanol, pentacosanol, hexacosanol, heptacosanol, octacosanol, nonacosanol, triacontanol, hentriacontanol and dotriacontanol. Among these, the long-chain alcohol having 12-25 carbon atoms, in particular the n-octadecanol is preferable, since aqueous polyurethane resin compositions having excellent barrier properties can be obtained by using it.

The method to manufacture the isocyanurate compound of component (a) is not limited in particular in the present invention. It is manufactured easily by adding 1.2 mol of long-chain alkyl alcohols to 1 mol of isocyanurate at one time or stepwise to carry out thereto-reaction

Examples of the long-chain alkylene diol compound (b) having 10-32 carbon atoms used in the present invention are straight chain or branched diols such as decanediol, undecanediol, dodecanediol, tridecanediol, tetradecanediol, pentadecanediol, hexadecanediol, heptadecanediol, octadecandiol, nonadecandiol, icosanediol, henicosandiol, docosandiol, tricosandiol, tetracosandiol, pentacosandiol, hexacosandiol, heptacosandiol, octacosandiol, nonacosandiol, triacontandiol, hentriacontandiol and dotriacontandiol. The long-chain alcohol having 12-18 carbon atoms, in particular the 1,12-dodecanediol or 1,12-octadecanediol etc. is preferable among these since aqueous polyurethane resin compositions having excellent barrier properties can be obtained by using them.

Examples of the polyisocyanate compounds of component (c) used in the present invention are aromatic diisocyanates such as tolylene diisocyanate, diphenylmethane-4,4′-diisocyanate, p-phenylenediisocyanate, xylylenediisocyanate, 1,5-naphthylenediisocyanate, 3,3′-dimethyldiphenyl-4,4′-diisocyanate, dianisidine diisocyanate and tetramethylxylylene diisocyanate; alicyclic diisocyanates such as isophorone diisocyanate, dicyclohexylmethane-4,4′-diisocyanate, trans and/or cis-1,4-cyclohexane diisocyanate and norbornene diisocyanate; aliphatic diisocyanates such as 1,6-hexamethylene diisocyanate, 2,2,4 and/or (2,4,4)-trimethylhexamethylene diisocyanate and lysine diisocyanate: and mixtures thereof. They may be used in the form of modified components such as carbodiimide-modified and biuret-modified or in the form of block isocyanate blocked with various blocking agents. In the present invention, it is preferable to use tolylene-diisocyanate, isophoronediisocyanate and dicyclohexylmethane-4,4′-diisocyanate etc. among them from standpoints of easy-to obtain, easy-to handle and a mechanical physical properties.

A polyisocyanate having three or more isocyanate groups can be used if required. Examples of these polyisocyanates are isocyanates having three or more isocyanate groups such as triphenylmethane triisocyanate, 1-methylbenzol-2,4,6-triisocyanate, dimethyl triphenylmethane tetraisocyanate and mixtures thereof; modified components such as carbodiimide modified, isocyanurate modified or biuret modified of the isocyanate having three or more isocyanate groups; a block isocyanate of the polyisocyanate blocked by various blocking agents, an isocyanurate trimer of the diisocyanate cited above and a biuret trimer etc.

The polyol compound of component (d) used in the present invention is a diol which forms an urethane bond by reacting with the isocyanate group contained in the isocyanurate compound of the above component (b) or contained in the polyisocyanate compound of the component (c). In addition, other polyols having three or more hydroxyl groups can be optionally used if required. The blending etc. thereof is not limited in particular.

Examples of diols used as the above polyol compound and polyols having three or more hydroxyl groups are low-molecular polyols, polyetherpolyols, polyesterpolyols, polyesterpolycarbonatepolyols and crystalline or non-crystalline polycarbonatepolyols.

Examples of the above low-molecular polyols are aliphatic diols such as ethylene glycol, 1,2-propanediol, 1,3-propanediol, 2-methyl-1,3-propanediol, diethyleneglycol, triethyleneglycol, 2-butyl-2-ethyl-1,3-propanediol, 1,4-butanediol, neopentylglycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-heptanediol, 3,5-heptanediol, 1,8-octanediol, 2-methyl-1,8-octanediol, 1,9-nonanediol and 1,10-decanediol; alicyclic dials such as cyclohexanedimethanol and cyclohexanediol; trivalent or more polyols such as trimethylol ethane, trimethylol propane, hexytols, pentitols, glycerin, polyglycerin, pentaerythritol, dipentaerythritol, tetramethylol propane.

Examples of the above polyether polyols are 1,2-propanediol, 1,3-propanediol; the above low-molecular polyols such as trimethylol propane, glycerin, polyglycerin and pentaerythritol; and further, bisphenol A, ethyleneoxide addition products and/or propyleneoxide addition products of amine compounds such as ethylenediamine; polytetramethylene-etherglycol etc. It is preferable that the average molecular weight of polyether polyols used for the present invention is 300-5000, particularly 1000-3000 is better.

Examples of the above polyesterpolyols are products obtained by direct esterification reaction and/or transesterification of the polyols, such as low-molecular polyols cited before, with an amount less than stoichiometric amount of polycarboxylic acid/or ester producible derivatives thereof such as ester, anhydride or halide thereof; and/or lactones or hydroxycarboxylic acid obtained by a hydrolysis ring-opening reaction of the lactones. Examples of the above polycarboxylic acid or its ester producible derivative are aliphatic dicarboxylic acids such as oxalic acid, malonic acid, succinic acid, glutaric acid, adipic acid, pimelic acid, suberic acid, azelaic acid, sebacic acid, dodecanedioic acid, 2-methyl succinic acid, 2-methyl adipic acid, 3-methyl adipic acid, 3-methyl pentanedioic acid, 2-methyl octanedioic acid, 3,8-dimethyldecanedioic acid, 3,7-dimethyldecanedioic acid, hydrogenerated dimer acid and dimer acid; aromatic dicarboxylic acids such as phthalic acid, terephthalic acid, isophthalic acid and naphthalenedicarboxylic acid; alicyclic dicarboxylic acids such as cyclohexanedicarboxylic acid; tricarboxylic acids such as trimellitic acid, trimesic acid and trimers of castor oil fatty acid; polycarboxylic acids such as tetracarboxylic acids like pyromeritic acids. Examples of ester producible derivatives of these polycarboxylic acids are these anhydrides, carboxylic acid halides such as chloride and bromide of the polycarboxylic acid, and lower fatty esters such as methylester, ethylester, propylester, isopropylester, butylester, isobutylester and amylester of the above polycarboxylic acids.

Examples of the above lactones are γ-caprolactone, δ-caprolactone, ε-caprolactone, dimethyl-ε-caprolactone, δ-valerolactone, γ-valerolactone, γ-butyrolactone. It is preferable that the average molecular weight of polyesterpolyols used for the present invention is 300-5000, particularly 500-3000 is better.

The anionic group-introducing compound used as the component (e) in the present invention is a compound used to introduce an anionic group into the polyurethane. The purpose to introduce an anionic group into polyurethane is to provide polyurethane with the dispersibility relative to water by neutralizing an anionic group with a neutralizing agent. Examples of the above anionic group are a carboxyl group, a sulfonic acid group, a phosphonic acid group and a boric acid group. In particular, from the viewpoints of excellence of dispersion relative to water and ease of introduction into the polyurethane, a carboxyl group and a sulfonic acid group are preferable. As the method of introducing an anionic group, the method to use diol having an anionic group is preferable since the operationality of the method is good as well as the control of the introduction amount (number) of the anionic group is easy.

Examples of the anionic group-introducing compound are polyols containing carboxyl groups such as dimethylol propionic acid, dimethylol butanoic acid, dimethylol butyric acid, dimethylol valeric acid; polyols containing a sulfonic acid group such as 1,4-butanediol-2-sulfonic acid. It is preferable that the quantity used of the above anionic group-introducing polyols is 5-1000 at molar ratio relative to 100 of polyol contained in the polyol component (d), particularly 10-500. If it is under 5, dispersion stabilization declines. If it is beyond 1000, the water resistance of coating film etc. obtained by coating aqueous polyurethane resin composition may decline.

The anionic group neutralizing agent (f) used in the present invention is a compound for neutralizing an anionic group so as to provide polyurethane with water dispersibility. Examples are trialkylamines such as trimethyl amine and triethylamine; tri-amines such as N,N-dialkylalkanolamines, N-alkyl-N,N-dialkanolamines, and trialkanolamines; basic compounds such as ammonia, sodium hydrate, potassium hydrate and lithium hydrate. It is preferable that the quantity of neutralizing agents used are 0.2-2.0 mol relative to 1 mol of anionic group, in particular 0.5-1.5 is preferable. Physical properties such as water resistance, strength and extension of coating film etc. obtained by coating aqueous polyurethane resin composition tends to drop even if the neutralizing agent is used too much or too less relative to the anionic group.

Furthermore a chain-extension agent component (g) can be used as an optional component in the present invention. The above chain-extension agent component can be used in selecting suitably from among commonly used chain-extension agent components are low-molecular-weight diamines such as ethylene diamine, propylene diamine, hexamethylene diamine, tolylene diamine, piperazine and 2-methyl piperazine; polyether diamines such as polyoxypropylene diamine and polyoxyethylene diamine; alicyclic diamines such as menthene diamine, isophorone diamine, norbornene diamine, bis(4-amino-3-methyldicyclohexyl)methane, diaminodicyclohexylmethane, bis(aminomethyl)cyclohexane and 3,9-bis(3-aminopropyl)-2,4,8,10-tetraoxaspiro(5,5)undecane; polyamines like aromatic diamines such as m-xylene diamine, α-(m-/p-aminophenyl)ethyl amine, m-phenylene diamine, diamino diphenylmethane, diamino diphenylsulfone, diamino diethyldimethyl diphenylmethane, diaminodiethyl diphenylmethane, dimethylthiotoluene diamine, diethyltoluene diamine and α,α′-bis(4-aminophenyl)-p-diisopropylbenzene; hydrazines such as succinic acid dihydrazide, adipic acid dihydrazide, sebacic acid dihydrazide, phthalic acid dihydrazide, hydrazine hydrate, 1,6-hexamethylenebis(N,N-dimethyl semicarbazide), 1,1,1′,1′-tetramethyl-4,4′-(methylene-di-para-phenylene)disemicarbazide and water.

These chain-extension agents can be used alone or in combination of several kinds. The amount of the chain-extension agent used depends on the molecular weight of polyurethane resin intended. Usually, a group having reactivity with an isocyanate group is 0.05-1 relative to one isocyanate group of the urethane polymer.

There is no limitation in the method of manufacturing aqueous polyurethane resin composition of the present invention in particular and common methods are applicable. Concrete examples of manufacturing methods are methods of synthesizing a prepolymer by carrying out a reaction in a solvent, which has high affinity for water as well as inactivity against reaction, then (1) adding the obtained prepolymer to water and dispersing it, or (2) adding water to the obtained prepolymer to disperse it.

Suitable examples of the solvent having high affinity for water as well as inactivity against reaction are acetone, methylethylketone, dioxane, tetrahydrofuran and N-methyl-2-pyrrolidone etc. 3-100 mass parts of these solvents are commonly used relative to 100 mass parts of the total amount of the above raw materials used for manufacturing the prepolymer. When solvents having a boiling point of less than 100° C. are used as the solvent, it is preferable to remove them by distillation under reduced pressure after the synthesis of the aqueous polyurethane resin.

The blending ratio of each component used for manufacturing aqueous polyurethane resin of the present invention is not limited in particular. However, it is preferable that a molar ratio of the group, which is reactive to the isocyanate group, relative to the isocyanate group is 0.3-2 in the reaction process, and 0.5-1.5 is particularly preferable.

The aqueous polyurethane resin composition of the present invention can be suitably diluted to use. In this case, the solid content concentration is not limited in particular. However, from the viewpoints of uniform dispersion and performance for operation to obtain coating film and molded body, it is preferable that the solid content concentration is 1-65 mass %, and 5-40 mass % is particularly preferable.

If necessary, commonly used cross-linking agents may be added when manufacturing the aqueous polyurethane resin composition of the present invention, in order to give polyurethane molecule a cross-linking structure. Examples of suitable cross-linking agents used for the aqueous polyurethane resin composition of the present invention are melamine, monomethylolmelamine, dimethylolmelamine, trimethylolmelamine, tetramethylolmelamine, pentamethylolmelamine, hexamethylolmelamine, methylated methylolmelamine, butylated methylolmelamine and melamine resin. In the present invention, it is preferable that inexpensive melamine, which is excellent in dispersibility against polyurethane, is suitably selected from among these.

Common emulsifying agents used for aqueous polyurethane resin may be used for the aqueous polyurethane resin composition of the present invention, if necessary. Examples of emulsifying agents are an anionic surfactant, a nonionic surfactant, a cationic surfactant, an amphoteric surfactant, a polymeric surfactant and a reactive surfactant. In the present invention, from viewpoints of obtaining a good emulsified composition and low price, it is preferable that an anionic surfactant and a nonionic surfactant are used.

Examples of the above anionic surfactant are alkyl sulfates such as sodium dodecylsulfate, potassium dodecylsulfate, ammonium dodecylsulfate; polyoxyethylene ether sulfates such as sodium dodecylpolyglycolethersulfate, ammonium polyoxyethylene alkylethersulfate; sodium sulphorichinolates; alkyl sulfonates such as alkali metal salt of sulfonated paraffin, ammonium salt of sulfonated paraffin; fatty acid salts such as sodium laurate, triethanolamine oleate, triethanolamine abietate;

alkylarylsulfonates such as sodium benzenesulfonate, alkali metal sulfate of alkali phenolhydroxyethylene; high alkylnaphthalenesulfonic acid salt; naphthalenesulfonic acid formalin condensation; dialkylsulfosuccinate salt; polyoxyethylenealkylsulfate salt; polyoxyethylenealkylarylsulfate salt; polyoxyethylene ether phosphate salt; polyoxyethylenealkylether acetate; N-acylamino acid salt; and N-acylmethyl taurinate.

Examples of the above nonionic surfactant are fatty acid partial esters of polyalcohol such as sorbitan monolaurate, sorbitan monooleate; polyoxyethyleneglycol fatty acid esters; polyglycerine fatty acid esters; ethylene oxide and/or propylene oxide addition products of alcohol having 1-18 carbon atoms; ethylene oxide and/or propylene oxide of alkylphenol; ethylene oxide and/or propylene oxide addition products of alkyleneglycol and/or alkylenediamine. Examples of alcohol having 1-18 carbon atoms constituting these nonionic surfactants are methanol, ethanol, propanol, 2-propanol, butanol, 2-butanol, tertiary butanol, amyl alcohol, isoamylalcohol, tertiary amylalcohol, hexanol, octanol, decane alcohol, lauryl alcohol, myristyl alcohol, palmityl alcohol and stearyl alcohol.

Examples of the above alkylphenol are phenol, methylphenol, 2,4-di-tert-butylphenol, 2,5-di-tert-butylphenol, 3,5-di-tert-butylphenol, 4-(1,3-tetramethylbutyl)phenol, 4-isooctylphenol, 4-nonylphenol, 4-tert-octylphenol, 4-dodecylphenol, 2-(3,5-dimethylheptyl)phenol, 4-(3,5-dimethylheptyl)phenol, naphtol, bisphenol A and bisphenol F.

Examples of alkyleneglycol are ethylene glycol, 1,2-propanediol, 1,3-propanediol, 2-methyl-1,3-props nediol, 2-butyl-2-ethyl-1,3-propanediol, 1,4-butanediol, neopentylglycol, 1,5-pentanediol, 3-methyl-1,5-pentanediol, 2,4-diethyl-1,5-pentanediol, 1,6-hexanediol. Examples of alkylenediamine are compounds obtained by replacing alcoholic hydroxyl groups of above alkyleneglycols with amino groups. Addition products of ethyleneoxide and propyleneoxide may be random or block addition products.

There is no limitation in the amount of these emulsifying agents used in particular, however, it is preferable that it is 1-30 mass parts relative to 100 mass parts of polyurethane compound from viewpoints of physical properties such as water resistance, strength and extention of coating film obtained by coating aqueous polyurethane resin composition and 5-20 mass parts is better. If it is less than 1 mass part, sufficient dispersibility may not be obtained. If it is beyond 30 mass parts, the above physical properties of coating film etc. may decline.

If necessary, various types of additives used commonly may be used for the aqueous polyurethane resin composition of the present invention. Examples of these additives are, for example, pigment; dye; film-making auxiliary agent; curing agent; external cross-linking agent; viscosity-adjusting agent; leveling agent; antifoaming agent; antigelling agent; dispersion stabilizer such as surfactant; light stabilizer such as hindered amine; antioxidants such as phenol compound, phosphorus compound and sulfuric compound; ultraviolet absorbers such as triazine compound, benzoate compound and 2-(2-hydroxyphenyl)benzotriazole compound; radical-scavenger; heat resistance-providing agent; inorganic and organic filler; elasticizer; lubricant; antistatic agent; reinforcing agent; catalyzer; thixotropic agent; antibacterial agent; antifungus agent; antiseptic agent; and antirust agent.

When the aqueous polyurethane resin composition of the present invention is used for coating composition or coating agent, silane coupling agent, colloidal silica, tetraalkoxysilane and its condensation polymeraization compound, chelating agent and epoxy compound, which provide base materials with particularly strong adhesion properties, may be used.

When the aqueous polyurethane resin composition of the present invention is used for coating film or coating, which is exposed out of doors, it is preferable that hindered amine light stabilizer, ultraviolet absorber and antioxidant (phosphorus, phenol or sulfuric antioxidant) are used.

Examples of the above hindered amine light stabilizer are
2,2,6,6-tetramethyl-4-piperidylstearate,
1,2,2,6,6-pentamethyl-4-piperidylstearate,
2,2,6,6-tetramethyl-4-piperidylbenzoate,
bis(2,2,6,6-tetramethyl-4-piperidyl)sebacate,
bis(1,2,2,6,6-pentamethyl-4-piperidyl)sebacate,
bis(1-octoxy-2,2,6,6-tetramethyl-4-piperidyl)sebacate,
1,2,2,6,6-pentamethyl-4-piperidylmethylmethacrylate,
2,2,6,6-tetramethyl-4-piperidylmethylmethacrylate,
tetrakis(2,2,6,6-tetramethyl-4-piperidyl)-1,2,3,4-butanetetracarboxylate,
tetrakis(1,2,2,6,6-pentamethyl-4-piperidyl)-1,2,3,4-butanetetracarboxylate,
bis(2,2,6,6-tetramethyl-4-piperidyl)
bis(tridecyl)-1,2,3,4-butanetetracarboxylate,
bis(1,2,2,6,6-pentamethyl-4-piperidyl)
bis(tridecyl)-1,2,3,4-butanetetracarboxylate,
bis(1,2,2,6,6-pentamethyl-4-piperidyl)-2-butyl-2-(3,5-di-tert-butyl-4-hydroxy benzyl)malonate,
1-(2-hydroxyethyl)-2,2,6,6-tetramethyl-4-piperidynol/succinic acid diethyl condensation polymerization products,
1,6-bis(2,2,6,6-tetramethyl-4-piperidylamino)hexane/dibromoethane condensation polymerization products,
1,6-bis(2,2,6,6-tetramethyl-4-piperidylamino)hexane/2,4-dichloro-6-morpholino-s-triazine condensation polymerization products,
1,6-bis(2,2,6,6-tetramethyl-4-piperidylamino)hexane/2,4-dichloro-6-tert-octylamino-s-triazine condensation polymerization products,
1,5,8,12-tetrakis[2,4-bis(N-butyl-N-(2,2,6,6-tetramethyl-4-piperidyl)amino)-s-triazine-6-yl]-1,5,8,12-tetraazadodecane,
1,5,8,12-tetrakis[2,4-bis(N-butyl-N-(1,2,2,6,6-pentamethyl-4-piperidyl)amino)-s-triazine-6-yl]-1,5,8,12-tetraazadodecane,
1,6,11-tris[2,4-bis(N-butyl-N-(2,2,6,6-tetramethyl-4-piperidyl)amino)-s-triazine-6-ylamino]undecane,
1,6,11-tris[2,4-bis(N-butyl-N-(1,2,2,6,6-pentamethyl-4-piperidyl)amino)-s-triazine-6-ylamino]undecane,
3,9-bis[1,1-dimethyl-2-[tris(2,2,6,6-tetramethyl-4-piperidyloxycarbonyloxy)butylcarbonyloxy]ethyl]-2,4,8,10-tetraoxaspiro[5,5]undecane,
3,9-bis[1,1-dimethyl-2-[tris(1,2,2,6,6-pentamethyl-4-piperidyloxycarbonyloxy)butylcarbonyloxy]ethyl]-2,4,8,10-tetraoxaspiro[5,5]undecane.

Examples of the above ultraviolet absorber are 2-hydroxybenzophenones such as 2,4-dihydroxybenzophenone, 2-hydroxy-4-methoxybenzophenone, 2-hydroxy-4-octoxybenzophenone, 5,5′-methylenebis(2-hydroxy-4-methoxybenzophenone); 2-(2-hydroxyphenyl)benzotriazoles such as 2-(2-hydroxy-5-methylphenyl)benzotriazole, 2-(2-hydroxy-5-tert-octylphenyl)benzotriazole, 2-(2-hydroxy-3,5-di-tert-butylphenyl)-5-chlorobenzotriazole, 2-(2-hydroxy-3-tert-butyl-5-methylphenyl)-5-chlorobenzotriazole, 2-(2-hydroxy-3,5-dicumylphenyl)benzotriazole, 2,2′-methylenebis(4-tert-octyl-6-benzotriazolylphenol), polyethylene glycolester of 2-(2-hydroxy-3-tert-butyl-5-carboxyphenyl)benzotriazole, 2-[2-hydroxy-3-(2-acryloyloxyethyl)-5-methylphenyl]benzotriazole, 2-[2-hydroxy-3-(2-methacryloyloxyethyl)-5-tert-butylphenyl]benzotriazole, 2-[2-hydroxy-3-(2-methacryloyloxyethyl)-5-tert-octylphenyl]benzotriazole, 2-[2-hydroxy-3-(2-methacryloyloxyethyl)-5-tert-butylphenyl]-5-chlorobenzotriazole, 2-[2-hydroxy-5-(2-methacryloyloxyethyl)phenyl]benzotriazole, 2-[2-hydroxy-3-tert-butyl-5-(2-methacryloyloxyethyl)phenyl]benzotriazole, 2-[2-hydroxy-3-tert-amyl-5-(2-methacryloyloxyethyl)phenyl]benzotriazole, 2-[2-hydroxy-3-tert-butyl-5-(3-methacryloyloxypropyl)phenyl]-5-chlorobenzotriazole, 2-[2-hydroxy-4-(2-methacryloyloxymethyl)phenyl]benzotriazole, 2-[2-hydroxy-4-(3-methacryloyloxy-2-hydroxypropyl)phenyl]benzotriazole and 2-[2-hydroxy-4-(3-methacryloyloxypropyl)phenyl]benzotriazole; 2-(2-hydroxyphenyl)-4,6-diaryl-1,3,5-triazines such as 2-(2-hydroxy-4-methoxyphenyl)-4,6-diphenyl-1,3,5-triazine, 2-(2-hydroxy-4-hexyloxyphenyl)-4,6-diphenyl-1,3,5-triazine, 2-(2-hydroxy-4-octoxyphenyl)-4,6-bis(2,4-dimethylphenyl)-1,3,5-triazine, 2-[2-hydroxy-4-(3-C₁₂-C₁₃ mixed alkoxy-2-hydroxypropoxy)phenyl]-4,6-bis(2,4-dimethylphenyl)-1,3,5-triazine, 2-[2-hydroxy-4-(2-acryloyloxyetoxy)phenyl]-4,6-bis(4-methylphenyl)-1,3,5-triazine, 2-(2,4-dihydroxy-3-allylphenyl)-4,6-bis(2,4-dimethylphenyl)-1,3,5-triazine, 2,4,6-tris(2-hydroxy-3-methyl-4-hexyloxyphenyl)-1,3,5-triazine; benzoates such as phenyl salicylate, resorcinol monobenzoate, 2,4-di-tert-butylphenyl-3,5-di-tert-butyl-4-hydroxybenzoate, octyl(3,5-di-tert-butyl-4-hydroxy)benzoate, dodecyl(3,5-di-tert-butyl-4-hydroxy)benzoate, tetradecyl(3,5-di-tert-butyl-4-hydroxy)benzoate, hexadecyl(3,5-di-tert-butyl-4-hydroxy)benzoate, octadecyl(3,5-di-tert-butyl-4-hydroxy)benzoate and behenyl(3,5-di-tert-butyl-4-hydroxy)benzoate; substituted oxanilides such as 2-ethyl-2′-etoxyoxanilide and 2-etoxy-4′-dodecyoxanilide; cyanoacrylates such as ethyl-α-cyano-β, β-diphenylacrylate and methyl-2-cyano-3-methyl-3-(p-methoxyphenyl)acrylate; various kinds of metal salts or metal chelates, in particular nickel or chromium salts or chelates.

Examples of the above phosphorus antioxidant are triphenylphosphite, tris(2,4-di-tert-butylphenyl)phosphite, tris(2,5-di-tert-butylphenyl)phosphite, tris(nonylphenyl)phosphite, tris(dinonylphenyl)phosphite, tris(mixed nonylphenyl consisting of monononylphenyl and dinonylphenyl)phosphite, diphenyl acid phosphite, 2,2′-methylenebis(4,6-di-tert-butylphenyl)octylphosphite, diphenyldecylphosphite, diphenyloctylphosphite, di(nonylphenyl)pentaerythritol diphosphite, phenyldiisodecylphosphite, tributylphosphite, tris(2-ethylhexyl)phosphite, tridecylphosphite, trilaurylphosphite, dibutyl acid phosphite, dilauryl acid phosphite, trilauryltrithiophosphite, bis(neopentylglycol).1,4-cyclohexane dimethyldiphosphite, bis(2,4-di-tert-butylphenyl)pentaerythritol diphosphite, bis(2,5-di-tert-butylphenyl)pentaerythritol diphosphite, bis(2,6-di-tert-butyl-4-methylphenyl)pentaerythritol diphosphite, bis(2,4-dicumylphenyl)pentaerythritol diphosphite, distearylpentaerythritol diphosphite, tetra(C₁₂₋₁₅ mixed alkyl)-4,4′-isopropylidenediphenylphosphite, bis[2,2′-methylenebis(4,6-diamylphenyl)].isopropylidenediphenylphosphite, tetratridecyl.4,4′-butylidenebis(2-tert-butyl-5-methylphenol)diphosphite, hexa(tridecyl).1,1,3-tris(2-methyl-5-tert-butyl-4-hydroxyphenyl)butane.triphosphite, tetrakis(2,4-di-tert-butylphenyl)biphenylenediphosphonite, tris(2-[(2,4,7,9-tetrakis-tert-butyldibenzo[d,f][1,3,2]dioxaphosphepin-6-yl)oxy]ethyl)amine, 9,10-dihydro-9-oxa-10-phosphaphenanthrene-10-oxide, tris(2-[(2,4,8,10-tetrakis-tert-butyldibenzo[d,f][1,3,2]dioxaphosphepin-6-yl)oxy]ethyl)amine, 2-(1,1-dimethylethyl)-6-methyl-4-[3-4-[3-[[2,4,8,10-trakis(1,1-dimethylethyl)dibenzo[d,f][1,3,2]dioxaphosphepin-6-yl]oxy]propyl]-phenol 2-butyl-2-ethylpropanediol-2,4,6-tri-tert-butylphenol monophosphite.

The above phenol antioxidants are, for example, 2,6-di-tert-butyl-p-cresol, 2,6-diphenyl-4-octadecyloxayphenol, stearyl(3,5-di-tert-butyl-4-hydroxyphenyl)propionate, distearyl(3,5-di-tert-butyl-4-hydroxybenzyl)phosphonate, tridecyl.3,5-di-tert-butyl-4-hydroxybenzyl thioacetate, thiodiethylenebis[(3,5-di-tert-butyl-4-hydroxyphenyl)propionate], 4,4′-thiobis(6-tert-butyl-m-cresol), 2-octylthio-4,6-di(3,5-di-tert-butyl-4-hydroxyphenoxy)-s-triazine, 2,2′-methylenebis(4-methyl-6-tert-butylphenol), bis[3,3-bis(4-hydroxy-3-tert-butylphenyl)butyric acid]glycol ester, 4,4′-butylidenebis(2,6-di-tert-butylphenol), 4,4′-butylidenebis(6-tert-butyl-3-methylphenol), 2,2′-ethylidenebis(4,6-di-tert-butylphenol), 1,1,3-tris(2-methyl-4-hydroxy-5-tert-butylphenyl)butane, bis[2-tert-butyl-4-methyl-6-(2-hydroxy-3-tert-butyl-5-methylbenzyl)phenyl]terephthalate, 1,3,5-tris(2,6-dimethyl-3-hydroxy-4-tert-butylbenzyl)isocyanurate, 1,3,5-tris(3,5-di-tert-butyl-4-hydroxybenzyl)isocyanurate, 1,3,5-tris(3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, tetrakis[methylene-3-(3′,5′-di-tert-butyl-4′-hydroxyphenyl)propionate]methane, 2-tert-butyl-4-methyl-6-(2-acryloyloxy-3-tert-butyl 5-methylbenzyl)phenol, 3,9-bis[2-(3-tert-butyl-4-hydroxy-5-methylhydrocinnamoyloxy)-1,1-dimethylethyl]-2,4,8,10-tetraoxaspiro[5,5]undecane, triethyleneglycolbis[β-(3-tert-butyl-4-hydroxy-5-methylphenyl)propionate], and tocopherol.

The above sulfuric antioxidants are, for example, alkylthiodipropionates such as thiodipropionic acid esters with dilauryl, dimyristyl, myristylstearyl or distearyl; and β-alkylmercapto propionic acid esters of polyol such as pentaerythritol tetra(β-dodecylmercaptopropionate).

It is preferable that each amount used of the above hindered amine light stabilizer, ultraviolet absorber and antioxidant is 0.001-10 mass parts relative to 100 mass parts of aqueous polyurethane resin composition of the present invention (solid content if solvent is contained) and 0.01-5 mass parts is more preferable in particular. If it is less than 0.001 mass parts, sufficient addition effect may not be obtained. If it is more than 10 mass parts, dispersibility and physical properties of coating may be exacerbated. Addition methods of these hindered amine light stabilizer, ultraviolet absorber and antioxidant may be any of methods of adding to polyol component, adding to prepolymer and adding to aqueous phase at the time or after the time of water dispersion. However, the methods of adding to polyol component and adding to prepolymer are preferable from an easy-to handle standpoint.

The aqueous polyurethane resin composition of the present invention is used for coating compositions, adhesive agents, surface modification agents, organic and/or inorganic powder binder, molded body etc. Specifically, glass fiber sizing agent, coating agent for thermal recording, coating agent for inkjet paper, binder agent for printing ink, coating agent for steel plate, coating agent for agricultural film and coating composition for inorganic constructional materials such as glass, slate and concrete, coating composition for woodwork, fiber processing agent, sponge, puff, gloves and condom are cited. It is preferable to use as coating materials for coating composition, wood, paper, fiber, glass, electronic material parts and steel plate, in particular it is preferable to use as coating composition for surface-treated steel plate.

When the aqueous polyurethane resin composition of the present invention is used as a coating composition, methods such as brushing, roller coating, spray coating, gravure coating, reverse roll coating, air knife coating, bar coating, curtain roll coating, dip coating, rod coating and doctor blade coating can be suitably selected to apply to base materials.

The aqueous polyurethane resin composition of the present invention will now be described referring to examples, but the invention is not limited by these examples.

### Example 1

### Component (a)

### Synthesis of Isocyanurate Compound (a-1)

504 g (1.0 mol) of isocyanurate obtained from 1,6-hexamethylenediisocyanate, 268 g (1.0 mol) of stearyl alcohol and 772 g of N-methyl-2-pyrrolidone were introduced into a reaction flask. Then the reaction was carried out at 115-120° C. under a nitrogen atmosphere for two hours and the isocyanurate compound (a-1) was obtained by confirming that NCO % was 6.0% or less.

### 1. [Prepolymer Process (Synthesis of Polyurethane Resin Composition PP-01)]

96 g (0.062 mol) of the above isocyanurate compound (a-1) as a component (a), 20.5 g (0.0717 mol) of 1,12-octadecanediol (sovermol 912: commercial name, manufactured by Cognis Corporation) as a component (b), 159 g (0.607 mol) of dicyclohexylmethane-4,4′-diisocyanate (hydrogenerated MDI) as a component (c), 80 g (0.046 mol) of polyester polyol (number average molecular weight 1750) obtained from 1,6-hexanediol, adipic acid and isophthalic acid (mass ratio of adipic acid/isophthalic acid is 50/50) and 28 g (0.077 mol) of propylene oxide addition product of bisphenol A (number average molecular weight 360) as a component (d), 19.6 g (0.146 mol) of dimethylol propionic acid as a component (e), 6.4 g (0.051 mol) of melamine as a cross-linking agent and 121 g of N-methyl-2-pyrrolidone as a solvent were introduced into a reaction flask. The reaction was carried out at 100-120° C. under a nitrogen atmosphere for 2.5-3 hours and it was confirmed that NCO % was 3.9% or less. Then 14.7 g (0.146 mol) of triethylamine, 3.4 g of silane coupling agent (3-aminopropyltriethoxysilane, commercial name: Z6011, manufactured by TORAY•Dow Corning Corporation) and 0.9 g of benzotriazole were added to obtain the polyurethane resin composition (PP-01).

### 2. [Latex Process]

0.6 g of antifoaming agent (commercial name: B 1016, manufactured by ADEKA Corporation) and 2.7 g (0.027 mol) of triethylamine as a component (f) were added to 579 g of water while stirring. 500 g of the above polyurethane resin composition (PP-01) was added to the obtained water solution and stirring was carried out at 20-40° C. for 15 minutes. Then 32.8 g (0.14 mol) of a mixed solution of ethylenediamine/water (1/3) as a chain-extention agent was dropped and stirring was carried out at 20-40° C. for 10 minutes. Furthermore, 15.9 g (0.023 mol) of a mixed solution of adipic acid dihydrazide/water (1/3) was added as a chain-extention agent and stirring was continued at 20-40° C. for 1-2 hours until a NCO group disappeared to obtain the aqueous polyurethane resin composition.

### Example 2

### 1. Prepolymer Process

### Synthesis of Polyurethane Resin Composition PP-02

96 g (0.062 mol) of the above isocyanurate compound (a-1) as a component (a), 20.5 g (0.102 mol) of 1,12-dodecanediol as a component (b), 166 g (0.634 mol) of dicyclohexylmethane-4,4′-diisocyanate (hydrogenerated MDI) as a component (c), 75 g (0.043 mol) of polyester polyol (number average molecular weight 1750) obtained from 1,6-hexanediol, adipic acid and isophthalic acid (mass ratio of adipic acid/isophthalic acid is 50/50) and 26 g (0.072 mol) of propylene oxide addition product of bisphenol A (number average molecular weight 360) as a component (d), 19.6 g (0.146 mop of dimethylol propionic acid as a component (e), 6.0 g (0.048 mol) of melamine as a cross-linking agent and 121 g of N-methyl-2-pyrrolidone as a solvent were introduced into a reaction flask. The reaction was carried out at 100-120° C. under a nitrogen atmosphere for 2.5-3 hours and it was confirmed that NCO % was 4.0% or less. Then 14.8 g (0.147 mol) of triethylamine, 3.4 g of silane coupling agent (3-aminopropyltriethoxysilane, commercial name: Z6011, manufactured by TORAY Dow Corning Corporation) and 0.9 g of benzotriazole as a component (f) were added to obtain the polyurethane resin composition (PP-02).

### 2. Latex Process

0.6 g of antifoaming agent (commercial name: B 1016, manufactured by ADEKA Corporation) and 2.7 g (0.027 mol) of triethylamine as a component (f) were added to 579 g of water while stirring. 500 g of the above polyurethane resin composition (PP-02) was added to the obtained water solution and stirring was carried out at 20-40° C. for 15 minutes. Then 34.2 g (0.14 mol) of a mixed solution of ethylenediamine/water (1/3) as a chain-extention agent was dropped and stirring was carried out at 20-40° C. for 10 minutes. Furthermore, 16.5 g (0.024 mol) of a mixed solution of adipic acid dihydrazide/water (1/3) as a chain-extention agent was added and stirring was continued at 20-40° C. for 1-2 hours until a NCO group disappeared to obtain the aqueous polyurethane resin composition.

### Example 3

### 1. Prepolymer Process

### Synthesis of Polyurethane Resin Composition PP-03

96 g (0.062 mol) of the above isocyanurate compound (a-1) as a component (a), 41.0 g (0.143 mol) of 1,12-octadecanediol (commercial name: sovermol 912, manufactured by Cognis Corporation) as a component (b), 179 g (0.683 mol) of dicyclohexylmethane-4,4′-diisocyanate (hydrogenerated MDI) as a component (c), 40 g (0.023 mol) of polyester polyol (number average molecular weight 1750) obtained from 1,6-hexanediol, adipic acid and isophthalic acid (mass ratio of adipic acid/isophthalic acid is 50/50) and 28 g (0.077 mol) of propylene oxide addition product of bisphenol A (number average molecular weight 360) as a component (d), 19.6 g (0.146 mol) of dimethylol propionic acid as a component (e), 6.4 g (0.051 mol) of melamine as a cross-linking agent and 121 g of N-methyl-2-pyrrolidone as a solvent were introduced into a reaction flask. The reaction was carried out at 100-120° C. under a nitrogen atmosphere for 2.5-3 hours and it was confirmed that NCO % was 3.9% or less. Then 14.8 g (0.147 mol) of triethylamine, 3.4 g of silane coupling agent (3-aminopropyl triethoxysilane, commercial name: Z6011, manufactured by TORAY•Dow Corning Corporation) and 0.9 g of benzotriazole as a component (f) were added to obtain the polyurethane resin composition (PP-03).

### 2. Latex Process

0.6 g of antifoaming agent (commercial name: B 1016, manufactured by ADEKA Corporation) and 2.7 g (0.027 mol) of triethylamine as a component (f) were added to 579 g of water while stirring. 500 g of the above polyurethane resin composition (PP-03) was added to the obtained water solution and stirring was carried out at 20-40° C. for 15 minutes. Then 36.5 g (0.15 mol) of a mixed solution of ethylenediamine/water (1/3) as a chain-extention agent was dropped and stirring was carried out at 20-40° C. for 10 minutes. Furthermore, 17.6 g (0.025 mol) of a mixed solution of adipic acid dihydrazide/water (1/3) as a chain-extention agent was added and stirring was continued at 20-40° C. for 1-2 hours until a NCO group disappeared to obtain the aqueous polyurethane resin composition.

### Example 4

### 1. Prepolymer Process

### Synthesis of Polyurethane Resin Composition PP-04

96 g (0.062 mol) of the above isocyanurate compound (a-1) as a component (a), 20.5 g (0.0717 mol) of 1,12-octadecanediol (commercial name: sovermol 912, manufactured by Cognis Corporation) as a component (b), 174 g (0.664 mol) of dicyclohexylmethane-4,4′-diisocyanate (hydrogenerated MDI) as a component (c), 60 g (0.060 mol) of polyester polyol (number average molecular weight 1000) obtained from 2-methyl-1,5-pentanediol and adipic acid and 32 g (0.088 mol) of propylene oxide addition product of bisphenol A (number average molecular weight 360) as a component (d), 19.6 g (0.146 mol) of dimethylol propionic acid as a component (e), 7.3 g (0.058 mol) of melamine as a cross-linking agent and 122 g of N-methyl-2-pyrrolidone as a solvent were introduced into a reaction flask. The reaction was carried out at 100-120° C. under a nitrogen atmosphere for 2.5-3 hours and it was confirmed that NCO % was 4.2% or less. Then 14.8 g (0.147 mol) of triethylamine, 3.4 g of silane coupling agent (3-aminopropyl triethoxysilane, commercial name: Z6011, manufactured by TORAY•Dow Corning Corporation) and 0.9 g of benzotriazole as a component (f) were added to obtain the polyurethane resin composition (PP-04).

### 2. Latex Process

0.6 g of antifoaming agent (commercial name: B 1016, manufactured by ADEKA Corporation) and 2.7 g (0.027 mol) of triethylamine as a component (f) were added to 579 g of water while stirring. 500 g of the above polyurethane resin composition (FP-04) was added to the obtained water solution and stirring was carried out at 20-40° C. for 15 minutes. Then 35.6 g (0.15 mol) of a mixed solution of ethylenediamine/water (1/3) as a chain-extention agent was dropped and stirring was carried out at 20-40° C. for 10 minutes. Furthermore, 17.2 g (0.025 mol) of a mixed solution of adipic acid dihydrazide/water (1/3) was added and stirring was continued at 20-40° C. for 1-2 hours until, a NCO group disappeared to obtain the aqueous polyurethane resin composition.

### Example 5

### 1. Prepolymer Process

### Synthesis of Polyurethane Resin Composition PP-05

96 g (0.062 mol) of the above isocyanurate compound (a-1) as a component (a), 20.5 g (0.0717 mol) of 1,12-octadecanediol (commercial name: sovermol 912, manufactured by Cognis Corporation) as a component (b), 144 g (0.646 mol) of isophorone diisocyanate (IPDI) as a component (c), 90 g (0.051 mol) of polyester polyol (number average molecular weight 1750) obtained from 1,6-hexanediol, adipic acid and isophthalic acid (mass ratio of adipic acid/isophthalic acid is 50/50) and 32 g (0.088 mol) of propylene oxide addition product of bisphenol A (number average molecular weight 360) as a component (d), 19.6 g (0.146 mol) of dimethylol propionic acid as a component (e), 7.2 g (0.057 mol) of melamine as a cross-linking agent and 121 g of N-methyl-2-pyrrolidone as a solvent were introduced into a reaction flask. The reaction was carried out at 100-120° C. under a nitrogen atmosphere for 2.5-3 hours and it was confirmed that NCO % was 4.1% or less. Then 14.7 g (0.146 mol) of triethylamine, 3.4 g of silane coupling agent (3-aminopropyl triethoxysilane, commercial name: Z6011, manufactured by TORAY•Dow Corning Corporation) and 0.9 g of benzotriazole were added to obtain the polyurethane resin composition (PP-05).

### 2. Latex Process

0.6 g of antifoaming agent (commercial name B 1016, manufactured by ADEKA Corporation) and 2.7 g (0.027 mol) of triethylamine as a component (f) were added to 579 g of water while stirring. 500 g of the above polyurethane resin composition (PP-05) was added to the obtained water solution and stirring was carried out at 20-40° C. for 15 minutes. Then 34.8 g (0.14 mol) of a mixed solution of ethylenediamine/water (1/3) as a chain-extention agent was dropped and stirring was carried out at 20-40° C. for 10 minutes. Furthermore, 16.8 g (0.024 mop of a mixed solution of adipic acid dihydrazide/water (1/3) was added and stirring was continued at 20-40° C. for 1-2 hours until a NCO group disappeared to obtain the aqueous polyurethane resin composition.

### Comparative Example 1

### 1. Prepolymer Process

### Synthesis of Polyurethane Resin Composition PP-06

Without adding any of component (a) or (b), 166 g (0.634 mol) of dicyclohexylmethane-4,4′-diisocyanate (hydrogenerated MDI) as a component (c), 134 g (0.077 mol) of polyester polyol (number average molecular weight 1750) obtained from 1,6-hexanediol, adipic acid and isophthalic acid (mass ratio of adipic acid/isophthalic acid is 50/50) and 37 g (0.10 mol) of propylene oxide addition product of bisphenol A (number average molecular weight 360) as a component (d), 17.3 g of dimethylol propionic acid as a component (e), 7.4 g (0.059 mol) of melamine as a cross-linking agent and 171 g of N-methyl-2-pyrrolidone as a solvent were introduced into a reaction flask. The reaction was carried out at 100-120° C. under a nitrogen atmosphere for 2, 5-3 hours and it was confirmed that NCO % was 3.6% or less. Then 13.0 g (0.129 mol) of triethylamine, 3.4 g of silane coupling agent (3-aminopropyl triethoxysilane, commercial name: Z6011, manufactured by TORAY•Dow Corning Corporation) and 0.9 g of benzotriazole as a component (f) were added to obtain the polyurethane resin composition (PP-06).

### 2. Latex Process

0.6 g of antifoaming agent (commercial name: B 1016, manufactured by ADEKA Corporation) and 2.4 g (0.023 mol) of triethylamine as a component (f) were added to 579 g of water while stirring. 500 g of the above polyurethane resin composition (PP-06) was added to the obtained water solution and stirring was carried out at 20-40° C. for 15 minutes. Then 31.1 g (0.13 mol) of a mixed solution of ethylenediamine/water (1/3) as a chain-extention agent was dropped and stirring was carried out at 20-40° C. for 10 minutes. Furthermore, 15.0 g (0.022 mol) of a mixed solution of adipic acid dihydrazide/water (1/3) was added and stirring was continued at 20-40° C. for 1-2 hours until a NCO group disappeared to obtain the aqueous polyurethane resin composition.

### Comparative Example 2

### 1. Prepolymer Process

### Synthesis of Polyurethane Resin Composition PP-07

Without adding a component (a), 18.0 g (0.0629 mol) of 1,12-octadecanediol (sovermol 912: commercial name, manufactured by Cognis Corporation) as a component (b), 184 g (0.702 mol) of dicyclohexylmethane-4,4′-diisocyanate (hydrogenerated MDI) as a component (c), 99 g (0.057 mol) of polyester polyol (number average molecular weight 1750) obtained from 1,6-hexanediol, adipic acid and isophthalic acid (mass ratio of adipic acid/isophthalic acid is 50/50) and 35 g (0.097 mol) of propylene oxide addition product of bisphenol A (number average molecular weight 360) as a component (d), 17.3 g (0.129 mol) of dimethylol propionic acid as a component (e), 8.0 g (0.064 mol) of melamine as a cross-linking agent and 171 g of N-methyl-2-pyrrolidone as a solvent were introduced into a reaction flask. The reaction was carried out at 100-120° C. under a nitrogen atmosphere for 2.5-3 hours and it was confirmed that NCO % was 4.0% or less. Then 13.0 g (0.129 mol) of triethylamine, 3.4 g of silane coupling agent (Z6011: 3-aminopropyl triethoxysilane: commercial name, manufactured by TORAY•Dow Corning Corporation) and 0.9 g of benzotriazole as a component (f) were added to obtain the polyurethane resin composition (PP-07).

### 2. Latex Process

0.6 g of antifoaming agent (commercial name: B 1016, manufactured by ADEKA Corporation) and 2.4 g (0.023 mol) of triethylamine as a component (f) were added to 579 g of water while stirring. 500 g of the above polyurethane resin composition (PP-07) was added to the obtained water solution and stirring was carried out at 20-40° C. for 15 minutes. Then 34.4 g (0.14 mol) of a mixed solution of ethylenediamine/water (1/3) as a chain-extention agent was dropped and stirring was carried out at 20-40° C. for 10 minutes. Furthermore, 16.7 g (0.024 mol) of a mixed solution of adipic acid dihydrazide/water (1/3) was added and stirring was continued at 20-40° C. for 1-2 hours until a NCO group disappeared to obtain the aqueous polyurethane resin composition.

### Comparative Example 3

### 1. Prepolymer Process

### Synthesis of Polyurethane Resin Composition PP-08

Without adding a component (b), 96 g (0.062 mol) of the above isocyanurate compound (a-1) as a component (a), 142 g (0.542 mop of dicyclohexylmethane-4,4′-diisocyanate (hydrogenerated MDI) as a component (c), 113 g (0.065 mol) of polyester polyol (number average molecular weight 1750) obtained from 1,6-hexanediol, adipic acid and isophthalic acid (mass ratio of adipic acid/isophthalic acid is 50/50) and 33 g (0.091 mol) of propylene oxide addition product of bisphenol A (number average molecular weight 360) as a component (d), 19.6 g (0.146 mop of dimethylol propionic acid as a component (e), 8.0 g (0.064 mol) of melamine as a cross-linking agent and 121 g of N-methyl-2-pyrrolidone as a solvent were introduced into a reaction flask. The reaction was carried out at 100-120° C. under a nitrogen atmosphere for 2.5-3 hours and it was confirmed that NCO % was 3.4% or less. Then 14.8 g (0.147 mol) of triethylamine, 3.4 g of silane coupling agent (3-aminopropyl triethoxysilane, commercial name: Z6011 manufactured by TORAY•Dow Corning Corporation) and 0.9 g of benzotriazole as a component (f) were added to obtain the polyurethane resin composition (PP-08).

### 2. Latex Process

0.6 g of antifoaming agent (B 1016: commercial name, manufactured by ADEKA Corporation) and 2.7 g (0.027 mol) of triethylamine as a component (f) were added to 579 g of water while stirring. 500 g of the above polyurethane resin composition (PP-08) was added to the obtained water solution and stirring was carried out at 20-40° C. for 15 minutes. Then 27.7 g (0.12 mol) of a mixed solution of ethylenediamine/water (1/3) as a chain-extention agent was dropped and stirring was carried out at 20-40° C. for 10 minutes. Furthermore, 14.4 g (0.021 mol) of a mixed solution of adipic acid dihydrazide/water (1/3) was added and stirring was continued at 20-40° C. for 1-2 hours until a NCO group disappeared to obtain the aqueous polyurethane resin composition.

### Comparative Example 4

### 1. Prepolymer Process

### Synthesis of Polyurethane Resin Composition PP-09

96 g (0.062 mol) of the above isocyanurate compound (a-1) as a component (a), 20.5 g (0.174 mol) of 1,6-hexanediol instead of a component (b), 188 g (0.718 mol) of dicyclohexylmethane-4,4′-diisocyanate (hydrogenerated MDI) as a component (c), 64 g (0.064 mol) of polyester polyol (number average molecular weight 1000) obtained from 2-methyl-1,5-pentanediol and adipic acid and 16 g (0.044 mol) of propylene oxide addition product of bisphenol A (number average molecular weight 360) as a component (d), 19.6 g (0.146 mol) of dimethylol propionic acid as a component (e), 5.0 g (0.046 mol) of melamine as a cross-linking agent and 121 g of N-methyl-2-pyrrolidone as a solvent were introduced into a reaction flask. The reaction was carried out at 100-120° C. under a nitrogen atmosphere for 2.5-3 hours and it was confirmed that NCO % was 4.5% or less. Then 14.7 g (0.146 mol) of triethylamine, 3.4 g of silane coupling agent (3-aminopropyl triethoxysilane, commercial name: Z6011, manufactured by TORAY•Dow Corning Corporation) and 0.9 g of benzotriazole were added to obtain the polyurethane resin composition (PP-09).

### 2. Latex Process

0.6 g of antifoaming agent (commercial name: B 1016, manufactured by ADEKA Corporation) and 2.7 g (0.027 mol) of triethylamine as a component (f) were added to 579 g of water while stirring. 500 g of the above polyurethane resin composition (PP-09) was added to the obtained water solution and stirring was carried out at 20.40° C. for 15 minutes. Then 38.3 g (0.16 mol) of a mixed solution of ethylenediamine/water (1/3) as a chain-extention agent was dropped and stirring was carried out at 20-40° C. for 10 minutes. Furthermore, 18.5 g (0.027 mol) of a mixed solution of adipic acid dihydrazide/water (1/3) was added and stirring was continued at 20-40° C. for 1-2 hours until a NCO group disappeared to obtain the aqueous polyurethane resin composition.

### Comparative Example 5

An aqueous polyurethane resin composition was manufactured in the same blending ratio and condition as the ones of Example 1 except that component (e) was not added. However, the urethane prepolymer did not disperse into water and the aqueous polyurethane resin composition was not obtained.

### Comparative Example 6

An aqueous polyurethane resin composition was manufactured to the same blending ratio and condition as the ones of Example 1 except that component (f) was not added. However, the urethane prepolymer did not disperse into water and the aqueous polyurethane resin composition was not obtained.

<Performance Evaluation>

The barrier properties of coating films formed from aqueous polyurethane resin compositions obtained by the above Examples 1-5 and Comparative Examples 1-4 were evaluated as follows. Results are shown in Table 1.

### [Production of Test Samples]

Defatting treatment was carried out at 60° C. for 5 minutes with a defatting agent having pH 11-13, using a steel plate galvanized with zinc as a base material. Then the aqueous polyurethane resin compositions obtained by the above Examples 1-5 or Comparative examples 1-4 were applied to form 1 μm thick layer on the defatting-treated steel plate, then exposed under the atmosphere at 300° C. for 4 seconds and was dried with heat so that the steel plate temperature rises at 75° C. to make a test sample.

### [Water Resistance Properties Test]

A water resistance spot test was carried out at 65° C. under 95% RH for 24 hours, using the above test sample. The appearance of coating film was evaluated visually after the test, based on the following standard.

5. Nothing abnormal in coating film
4. Embossed coating film was 5% or less of the whole area
3. Embossed coating film was 6-20% of the whole area
2. Embossed coating film was 21% or more of the whole area
1. Coating film came off completely

### [Acid Resistance Test]

Immersion was carried out at 25° C. in 1% H₂SO₄ aqueous solution for 24 hours, using the above test sample, then the appearance of coating film was evaluated visually, based on the following standard.
5. Nothing abnormal in coating film
4. Embossed coating film was 5% or less of the whole area
3. Embossed coating film was 6-20% of the whole area
2. Embossed coating film was 21% or more of the whole area
1. Coating film came off completely

### [Alkali Resistance Test]

Immersion was carried out at 25° C. in 1% NₐOH aqueous solution for one hour, using the above test sample, then the appearance of coating film was evaluated visually, based on the following standard.

5. Nothing abnormal in coating film
4. Embossed coating film was 5% or less of the whole area
3. Embossed coating film was 6-20% of the whole area
2. Embossed coating film was 21% or more of the whole area
1. Coating film came off completely

TABLE 1

| | | Example | | | | | Comparative example | | | |
|---|---|---|---|---|---|---|---|---|---|---|
| | | 1 | 2 | 3 | 4 | 5 | 1 | 2 | 3 | 4 |
| Component | Compound | 23.5 | 23.5 | 23.5 | 23.5 | 23.5 | — | — | 23.5 | 23.5 |
| (a) | (a-1)*¹ | | | | | | | | | |
| Component | Compound | 5.0 | — | 10.0 | 5.0 | 5.0 | — | 5.0 | — | — |
| (b) | (b-1)*² | | | | | | | | | |
| | Compound | — | 5.0 | — | — | — | — | — | — | — |
| | (1-2)*³ | | | | | | | | | |
| Component | Compound | 38.8 | 40.6 | 43.7 | 42.5 | 45.9 | 50.9 | 34.6 | 46.0 | — |
| (c) | (c-1)*⁴ | | | | | | | | | |
| | Compound | — | — | — | — | 35.2 | — | — | — | — |
| | (c-2)*⁵ | | | | | | | | | |
| Component | Compound | 19.5 | 18.3 | 9.8 | — | 22.0 | 37.1 | 27.4 | 27.6 | — |
| (d) | (d-1)*⁶ | | | | | | | | | |
| | Compound | — | — | — | 14.7 | — | — | — | — | 16.6 |
| | (d-2)*⁷ | | | | | | | | | |
| | 1,6- | — | — | — | — | — | — | — | 5.0 | — |
| | hexanediol | | | | | | | | | |
| Evaluation | Water | 5 | 5 | 5 | 4 | 5 | 1 | 3 | 1 | 2 |
| | resistance | | | | | | | | | |
| | properties | | | | | | | | | |
| | Acid | 5 | 5 | 5 | 3 | 5 | 1 | 3 | 1 | 2 |
| | resistance | | | | | | | | | |
| | properties | | | | | | | | | |
| | Alkali | 4 | 4 | 5 | 4 | 4 | 3 | 3 | 3 | 4 |
| | resistance | | | | | | | | | |
| | properties | | | | | | | | | |

Numeric values of each component in the Table indicate mass % in urethane prepolymer*
(*{component (a) + (b) + (c) + (d) + (e)})
Component (e) is the amount wherein acid number value in the above urethane prepolymer is 20 mgKOH/g.
Component (f) is the amount wherein neutralization rate relative to acid number value of the above urethane prepolymer is 120%.
*¹the above isocyanurate compound (Reaction product of isocyanurate of 1,6-hexamethylenecliisocyanate with stearyl alcohol)
*²1,12-octadecanediol
*³1,12-dodecanediol
*⁴hydrogenerated MDI
*⁵IPDI
*⁶polyester polyol (1,6-hexanediol and adipic acid/polyester polyol of isophthalic acid)
*⁷polyester polyol (polyester polyol of 3-methyl-1,5-pentanediol with adipic acid)

As is clear from the above results, it was confirmed that Comparative Example 1 wherein neither components (a) nor (b) was not used, Comparative Example 2 wherein only component (a) was not used, Comparative Example 3 wherein only component (b) was not used and Comparative Example 4 wherein short-chain alkylenediol was used instead of long-chain alkylenediol of component (b) were poor in barrier properties and good results were obtained only by the compositions of the present invention.

### INDUSTRIAL APPLICABILITY

The aqueous polyurethane resin composition of the present invention can provide coating film having excellent water resistance and chemical resistance (acid resistance, alkali resistance). In addition, the aqueous polyurethane resin composition of the present invention is suitable for manufacturing materials and molded articles, having excellent water resistance and chemical resistance (acid resistance, alkali resistance) by coating surfaces of wood, paper, fiber, glass, electronic material parts and steel plate, since aqueous system will not destroy environment and has excellent working properties as well.

1. An aqueous polyurethane resin composition characterized in that an isocyanurate compound (a) represented by the following general formula (1), a long-chain alkylenediol compound (b) having 10-32 carbon atoms, a polyisocyanate compound (c), a polyol compound (d), an anionic group-introducing compound (e), an anionic group neutralizing agent (f) and water are essential components; 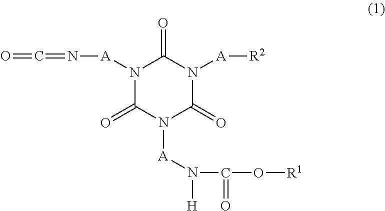
wherein R¹ in the formula represents an alkyl group having 10-32 carbon atoms, and R² is —N═C═O, or 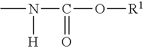
and A represents a residue produced by removing two —N═C═O from a diisocyanate compound.

2. The aqueous polyurethane resin composition according to claim 1, wherein A in the general formula (1) is a hexamethylene group produced by removing two —N═C═O from 1,6-hexamethylenediisocyanate.

3. The aqueous polyurethane resin composition according to claim 1, wherein R¹ in the above general formula (1) is an alkyl group having 12-18 carbon atoms.

4. The aqueous polyurethane resin composition according to claim 2, wherein R¹ in the general formula (1) is an alkyl group having 12-18 carbon atoms.

5. The aqueous polyurethane resin composition according to claim 1, wherein R² in the general formula (1) is —N═C═O.

6. The aqueous polyurethane resin composition according to claim 2, wherein R² in the general formula (1) is —N═C═O.

7. The aqueous polyurethane resin composition according to claim 1, wherein the long-chain alkylenediol compound (b) is an alkylenediol having 12-18 carbon atoms.

8. The aqueous polyurethane resin composition according to claim 2, wherein the above long-chain alkylenediol compound (b) is an alkylenediol having 12-18 carbon atoms.

9. A coated article characterized in that a surface of plate material is coated with an aqueous polyurethane resin composition of claim 1.

10. The coated article according to claim 9, wherein the plate material is a surface-treated steel plate.
